(19) United States
(12) Patent Application Publication
(10) Pub. No.: US 2006/0170391 A1
(43) Pub. Date: Aug. 3, 2006

(54) Fuel cell charger

(76) Inventor: Duhane Lam, Vancouver (CA)

Correspondence Address: ANGSTROM POWER;GERARD FRANCIS MCLEAN, 1776 YORKTOWN STREET, SUITE 550, HOUSTON, TX, 77056, US

(21) Appl. No.: 11/342,005

(22) Filed: Jan. 27, 2006

Related U.S. Application Data
(60) Provisional application No. 60/647,899, filed on Jan. 28, 2005.

(51) Int. Cl. H02J 7/35

(52) U.S. Cl. 320/101

(57) ABSTRACT

A fuel cell charger and a method of using a fuel cell charger. The charger includes a housing, a communication/power port, disposed in the housing, and at least one fuel cell adapted to generate electricity. The fuel cell includes a fuel plenum containing fuel, an anode connected to the fuel plenum, a cathode in communication with oxidant, ion-conducting electrolyte disposed between the anode and cathode, a positive connection, and a negative connection. There can also be circuitry adapted to provide power to an electronic device through the communication/power port.

### CROSS REFERENCE TO RELATED APPLICATIONS

The present application claims priority to co-pending U.S. Provisional Patent Application Ser. No. 60/647,899 filed on Jan. 28, 2005.

### FIELD

The present embodiments relates to a charger for electronic devices, such as cell phones, MP3 players and digital cameras, using a fuel cell or multiple fuel cells, as well as a method for recharging or powering electronic devices, such as portable electronic devices like PDAs (Personal Digital Assistants) using at least one fuel cell and a system for recharging or powering these electronic devices that utilizes at least one fuel cell, or at least one fuel cell layer.

### BACKGROUND

Many portable electronic devices such as cell phones, Personal Digital Assistants (PDAs), MP3 payers and digital cameras use a rechargeable secondary battery for powering the device when it is not connected to grid power through an adapter. When this secondary battery runs out, the device no longer works. The battery must either be recharged or another device used. Running out of power is frustrating and annoying.

A need has existed for a device to recharge batteries in electronic devices that is portable, easy to carry, convenient, and inexpensive to manufacture.

A need has existed for a system for recharging portable electronic devices, like cell phones, in environments where connectivity to a power grid is limited and the user needs to operate the unit. An individual need only experience the frustration of not being able to make a critical phone call when away from home to understand the need for such a device, system and method. Similarly, the business person who must face 3 or 4 unproductive hours because their PDA has run out of power understands the same problems.

Industrial users have a need to extend the range of their electronic devices, especially portable electronic devices such as cell phones, radios, and portable lights, so they last at least the duration of one work shift. Recharging batteries in the middle of a shift, or requiring two sets of batteries for every device, is expensive because of the down time of having to recharge or the extra capital cost of stocking extra batteries.

The Coast Guard finds similar power problems while at sea. A need exists in the safety area for use in lifeboats, where power needs to be stored for long periods of time and then made available in an emergency situation without any other power sources available to run beacons, radios, and similar electronic devices.

A need exists for a solution for charging or powering portable electronic devices such as radios, alarms, beacons, GPS and other locating devices or extending their range without significantly reducing their portability. For example, a need exists for charging rechargeable batteries such as those used by the military while out in the field and away from grid power or other sources of power.

A need exists for a portable power solution that can charge a wide variety of electronic devices without the need for custom configurations or many different adaptors. Electronic devices such as cell phones and PDAs have different power connections, require different voltages and currents for charging, and typically require special adaptors to interface to a charging unit. A need exists for one device that can charge a wide variety of cell phones, as well as other electronic devices such as PDAs. Travelers who have carried three different sets of adaptors and cables for charging their cell phone, PDA, and digital camera respectively understand the need for one device that can charge more than one of their electronic devices. In particular, a need exists for a portable power solution that can charge a wide variety of electronic devices without the need for a new adaptor or special interface. A need exists for a power solution that can charge an electronic device using already existing and available cables, adaptors, and interfaces.

### SUMMARY

The present embodiments relate to a device for running and/or charging electronic, electric or other portable devices using a fuel cell charger. The present embodiments relate to a system for recharging using the fuel cell charger. In addition the present embodiments relate to a method for recharging using at least one fuel cell which is portable, easy to use and safe.

### BRIEF DESCRIPTION OF THE DRAWINGS

In the detailed description of the embodiments presented below, reference is made to the accompanying drawings, in which:

FIG. 1 depicts the overall system for charging an electronic device, a cell phone, using the fuel cell charger of an embodiment.

FIG. 2 depicts a fuel cell that can be used in an embodiment.

FIG. 3 depicts an array of interconnected fuel cells.

FIG. 4 depicts a system using an embodiment of a fuel cell charger.

FIG. 5 depicts an embodiment of the overall system for charging an electronic device, a cell phone, using a fuel cell charger of an embodiment.

FIG. 6 is a schematic representation of a fuel cell charger according to an embodiment.

The present embodiments are detailed below with reference to the listed figures.

### DETAILED DESCRIPTION OF THE EMBODIMENTS

Before explaining the present embodiments in detail, it is to be understood that the embodiments are not limited to the particular descriptions and that the embodiments can be practiced or carried out in various ways.

The present embodiments allow users of electronic devices to recharge the secondary batteries in these devices, or stand-alone secondary batteries when grid power is not available or not convenient. For example, a user of a cell phone in the field away from grid power can find themselves with a dead battery and unable to make a critical call. The present embodiments would allow them to recharge their battery and make that call. This advantage is equally important in situations when the grid power has failed (e.g., blackouts), or in places where the grid power is unreliable. In the case of a blackout extending for several days, people can use the present embodiments to recharge their cell phone and thus maintain a communications link. The importance of this advantage is highlighted by the fact that the standard (non-cellular) phone network has its own power source so communications can be maintained even when grid power fails.

In the case of some electronic devices, the present embodiments can also allow users to run their electronic devices directly from the fuel cell charger as an alternative to, or at the same time, as recharging the secondary battery in the electronic device. This has advantages because the user does not have to wait for their battery to recharge. They can operate their device even if the secondary battery in it is completely dead. The fuel cell charger can be used to run an electronic device even when the battery is fully charged in order to save their battery, or to charge the battery while the electronic device is in use.

Another advantage of the present embodiments is the ability to extend the range of current electronic devices. The range of many of these devices is typically limited by how much energy can be stored in the secondary battery between charges. The fuel cell charger provides an advantage to the user by extending the time required between charges. For example, a user of an MP3 player can play more music and run the device for longer before having to return to somewhere with grid power to recharge the device.

Another advantage of the present embodiments is they reduce the number of charger devices required and the number of parts required to provide power to a wide variety of electronic devices. This is a significant advantage for both the consumer and the manufacturer. Electronic devices typically have different adaptors and different voltage/current requirements for charging. Previously, this would have necessitated manufacturing a specific charging device—a separate Stock-Keeping Unit (SKU)—for just about every different electronic device available. This would greatly reduce the utility of the chargers, and make the logistics of manufacturing and distributing such a product almost prohibitive. The present embodiments allow the manufacturer and user to use only one charger device (one SKU) to charge a wide variety of electronic devices by using a communications port—for example, a Universal Serial Bus (USB) port—already used by many electronic devices. Furthermore, the manufacturer of the charger is not required to design, make, and stock a wide variety of adaptors because the interface device or cable for hooking up to the standard communications port already exists in many cases. This is also appealing to the user.

For example, a user can have a cell phone and a digital camera, both of which can communicate and transfer data to a computer through a USB port. The present embodiments can allow the user to buy one fuel cell charger and use it for both devices, rather than buying separate chargers for each device. Thus, the user saves money and also does not have to worry about selecting the right adaptor for use with each device. Furthermore, the user can use the fuel cell charger as a power source for many other electronic devices that can be powered from a USB port. Two common examples of devices that can be powered from a USB port are fans and lights.

Other advantages of the present embodiments include the possibility of communicating between the fuel cell charger and electronic device. By using a communications port, communications standards can be used to provide information to the fuel cell charger about the electronic device being charged. For example, a PDA with a USB connection that is designed to charge through such a connection will typically exchange some data with the USB port when it is plugged in. This includes for example whether the port should supply one standard amount of current (e.g., 100 mA), or another standard amount of current (e.g., 200 mA). Traditional charger devices that provide strictly voltage and current without any communications are not able to adapt in this way to different devices, and are thus often limited to only being able to charge a specific device.

Furthermore, the present embodiments have a safety advantage because it would conform to the standard of the communications protocol being used (e.g., USB) and prevent damage to electronic devices as a result of supplying too much voltage or current. Electronic devices can easily be damaged with existing chargers if the charger is plugged into the wrong device and supplies power incorrectly. For example, using a USB communications port to supply power to a cell phone can prevent damage and improve safety by supplying the proper voltage and current expected by the cell phone.

Yet another advantage is the potential of using the data lines on the communication port for controlling the fuel cell charger. For example, the communication lines can be used to transmit data signaling to the fuel cell charger when to start and when to stop charging (e.g., the secondary battery is fully charged). Other information could also be passed between the electronic device the fuel cell charger. The information could be used to optimize the operation of the entire system, thus making the most efficient use of the available energy.

For example, the fuel cell charger could operate with electronic devices in a hybrid manner. The fuel cell charger would communicate with the electronic device and would decide whether it would be more efficient to run from the fuel cell charger or from the secondary battery. The present embodiments thus enable “smart chargers” through the use of a communication port such as a USB connection.

The fuel cell charger can be usable in “safe caves”, “bomb shelters” or other facilities where equipment and food are put away in case of a global crisis. Fuel cells typically have a longer shelf life than batteries. The reliability of the fuel cell charger would allow it to still work, after long hours of use, as well as after days of sitting without any use.

The method was devised to overcome a major problem with designing and building charger systems. The charging system can connect to many electronic devices without the need for a customized version of the fuel cell charger for each device, using existing interfaces such as cables and adaptors.

An embodiment contemplates a charger having a fuel cell, which is a device that converts a fuel, such as hydrogen, into electricity through and electrochemical reaction. Many other types of fuels, such as methanol, formic acid, other liquid fuels, or chemical hydride fuels such as sodium borohydride, sodium alanate, or lithium alanate, or liquefied gases such as butane or propane can also be used. In some embodiments, hydrogen fuel could be stored in a hydrogen storage material, such as a metal hydride. A fuel cell tends to obtain oxidant from the air or an oxidant source. A fuel cell can be used to supply power to a portable electronic device with this device, either to run the device or to recharge the battery in the device, or to charge the battery in the device while the device is in use. One example of a use of an embodiment of the system can be a charger for cell phones.

Other electronic devices could be powered or charged by the present embodiments, including safety beacons, Personal Digital Assistants (PDAs), MP3 players, DVDs, portable video cameras, digital cameras, laptops, RFID (Radio Frequency ID) tag readers, rechargeable batteries, fans, lights, and more.

The fuel cell charger in an embodiment can have a Universal Serial Bus (USB) port which is a type of communication power port originally designed for connecting computers to peripheral devices. USB ports are commonly used to connect devices such as PDAs and digital cameras to computers for the exchange of data. They are also used for transferring data to memory keys, and for connecting peripherals such as keyboards and mice. In addition to data transfer, part of the USB specification allows also for the supply of power to peripherals through the standard USB port at about 5 volts. This power is used to run peripheral devices including memory keys.

The USB bus voltage can be between 4.35 and 5.25 Volts, but can go as low as 4 Volts for transients. The typical maximum current from a USB port is 500 mA for steady state high power, and 100 mA for low power USB. However, there is capability for inrush currents up to 7.5 A. Detailed USB specifications are available from USB Implementers Forum Inc. of Portland Oreg. It is contemplated that the various embodiments can include various physical dimensions and sizes of a number of connectors, including USB A, USB B, mini USB, USB 2.0, USB 1.1 and others.

The present embodiments contemplate the use of various pin-outs, communication protocols, etc.

An embodiment of the fuel cell charger can have a housing, such as one of a durable plastic material, or it can be metal, such as aluminum or stainless steel laminates or combinations thereof.

A USB port can be attached to the housing of the charger. Electronic circuitry can be connected to the USB port; an example of the circuitry can be a voltage converter. Other types of circuitry can also be used, such as control and regulation circuitry. Other types of communication power ports can also be used instead of the USB ports, such as a VGA Video, SUN and SGI Video, MAC Video, SGI Open LDI, PS/2, PC/AT, serial mouse, RS232 DB9, RS232 DB25, USB Type A and B, Mini USB Type B, IEEE 1394, or a RS232 RJ45 connector.

The fuel cell itself can be one or a plurality of fuel cells, each adapted to generate electricity. If a plurality of fuel cells is used, they can be connected in parallel, or in series, or in some combination of these. The number of fuel cells that can be used is from 1 to 50,000 fuel cells. Many layers of micro-sized fuel cells can also be connected to make a fuel cell charger as contemplated by the present embodiments.

The fuel cells can also be nano-sized. Nano-sized can mean the fuel cells dimensions are measured in nano-meters such as from 3×10⁻⁹ to 9×10⁻⁹ meters. The fuel cell's electrode can be formed from a metal, conductive plastic, carbon, graphite, other materials or combinations thereof.

Each fuel cell can have a fuel plenum containing fuel, an anode in (fluid) communication with to the fuel plenum, and a cathode in (fluid) communication with oxidant. An ion-conductive electrolyte can separate the anode and the cathode. The fuel cell can be a direct methanol fuel cell, a reformed methanol fuel cell, a solid oxide fuel cell, an alkaline fuel cell, a polymer electrolyte membrane fuel cell, a proton exchange membrane fuel cell, a direct borohydride fuel cell or combinations of these. There can also be a shut off feature such as a valve that shuts off the flow of fuel from the fuel tank to the anode when the unit is not in use. Such a feature can help to extend the shelf life of the fuel cell charger.

Electronic circuitry would be used to provide power to an electronic device, like the safety beacon, the cell phone, the PDA, or similar device through the communication/power port. Other contemplated devices include an MP3 player, a bar code scanner, a portable laser pointer, a mini-projector, small televisions, fans, lights, and similar devices. Still other devices include secondary batteries that are not integrated into another device such as military batteries for powering portable radios. In an embodiment, a TREO 600 smart phone available from PalmOne of Milpitas, Calif., can be charged with the fuel cell charger device using a USB sync and charge cable available from http://store.treocentral.com. Of course, this is only one example and many other electronic devices can be charged using the same fuel cell charger.

A positive connection can engage the cathode on one end and an input of the electronic circuitry on the other end. A negative connection can engage the anode on one end and an input of the electronic circuitry on the other end. If there are many fuel cells connected together in series then the positive and negative connections can be attached to only the cathode of one fuel cell and the anode of another fuel cell in the array. The positive or negative connections can also be connected to any cathodes or anodes of a plurality of fuel cells connected in series. If many fuel cells are connected in parallel then the positive and negative connections can be connected to all of the cathodes and anodes of all of the fuel cells. Another positive connection can engage a positive output of the electronic circuitry on one end and the communication power port, such as the USB port, on the other end. Another negative connection can engage a negative output of electronic circuitry on one end and the communication power port on the other end. The communication power port will have yet another positive connection and yet another negative connection as the output of the fuel cell charger.

The circuitry can include a limiter to limit the output voltage, current, or power of the fuel cell charger or fuel cell. The circuitry can include limiters to limit the output voltage, current, or power of the fuel cells themselves in order to optimize the efficiency of the system. An on/off indicator lamp could also be included in the circuitry to provide user feedback as to whether the fuel cell charger is operating or not.

An electrolyte usable in the fuel cells of an embodiment can be an ion conducting membrane/electrolyte or a liquid electrolyte. An example of an ion conducting membrane can be a PFSA membrane, such as Nafion™, which is a perfluorosulfonic acid/polytetrafluoroethylene (PFSA/PTFE) copolymer in the acid form. Nafion™ is available from E.I. Dupont Company of Wilmington, Del.

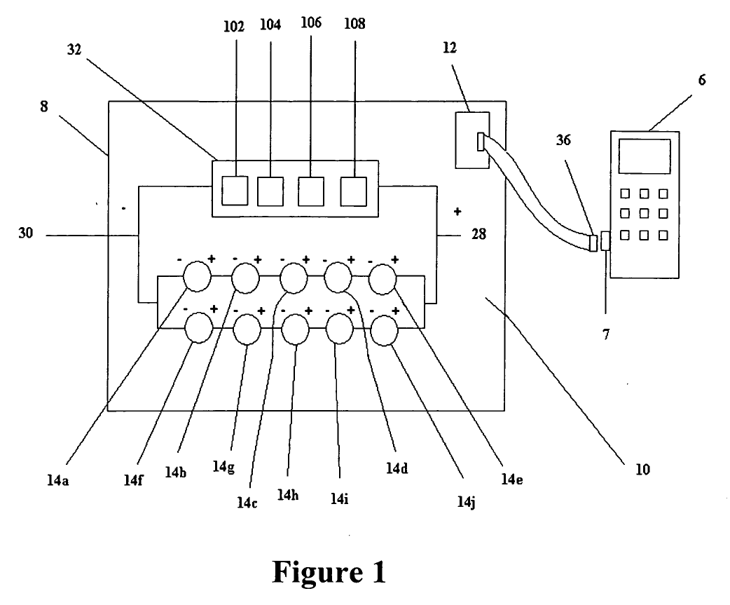

With reference to the figures, FIG. 1 is a fuel cell charger (8) according to one embodiment including a housing (10); a communication/power port (12) disposed in the housing; and at least one fuel cell (14a) adapted to generate electricity, wherein the fuel cell (14a) can be one or more fuel cells (14b, 14c, 14d, 14e, 14f, 14g, 14h, 14i, 14j). The fuel cell charger (8) includes circuitry (32) adapted to provide power to an electronic device through the communication power port (12). The fuel cell charger can be used to provide power to an electronic device (6) having at least one interface port (7). An interface (36) can be used for connecting the fuel cell charger (8) to the electronic device (6). The interface (36) can be a cable connection which engages the interface port (7) of the portable electronic device (6). The interface (36) of this figure can be an insulated cable or wire with two connections, one connection engaging the communication power port (12) and one connection engaging the electronic device (6) through the interface port (7) to provide to power and to communicate with the electronic device (6). As an alternative to a flexible cable, the interface (36) can also be a rigid connector, with one end adapted to engage the interface port (7) of the electronic device (6), and the other end adapted to engage the communication power port (12). Between the fuel cells (14) and the circuitry (32) can be a first positive connection (28) and a first negative connection (30). The circuitry (32) can further comprise an on/off indicator lamp (102), a first limiter (104) to limit the output voltage, current, or power of the fuel cell (14), and/or a second limiter (106) to limit the output voltage, current, or power of the fuel cell charger (8). The circuitry (32) can also include a DC-DC converter (108). The fuel cells (14) are shown connected together in both series and parallel. The fuel cells can be connected together in parallel, series, or other combinations of parallel and series connections. In this embodiment, the fuel is contemplated to be hydrogen and the electrolyte is contemplated to be a PFSA-based electrolyte, such as Nafion™, available from E.I. DuPont Nemours (a Delaware corporation), which is a PFSA/PTFE copolymer in the acid form.

It is contemplated that the charger produces a voltage from 3 to 9 Volts, preferably from 4.35 to 5.25 Volts. The current supplied can be from 0 to 10 Amps, or preferably from 0 to 500 mA.

It is also contemplated in another embodiment that the charging device can automatically activate when connected to an electronic device through the communication/power port.

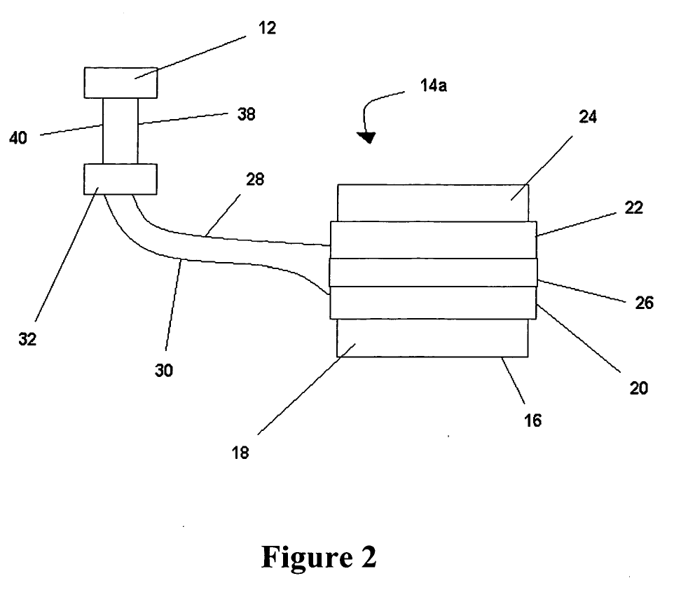

FIG. 2 is a detail of the at least one fuel cell (14a) adapted to generate electricity in communication with a fuel plenum (16) containing fuel (18). An anode (20) can be in communication with the fuel (18). A cathode (22) can be in communication with an oxidant (24) such as oxygen contained in ambient air. An ion-conducting electrolyte (26) can be disposed between the cathode (22) and the anode (20). A positive connection (28) can engage the cathode (22) and the electronic circuitry (32). A negative connection (30) can engage the anode (20) and the electronic circuitry (32). A second positive connection (38) can connect an output of the electronic circuitry (32) with the communication power port (12). A second negative connection (40) can connect an output of the electronic circuitry (32) with the communication power port (12).

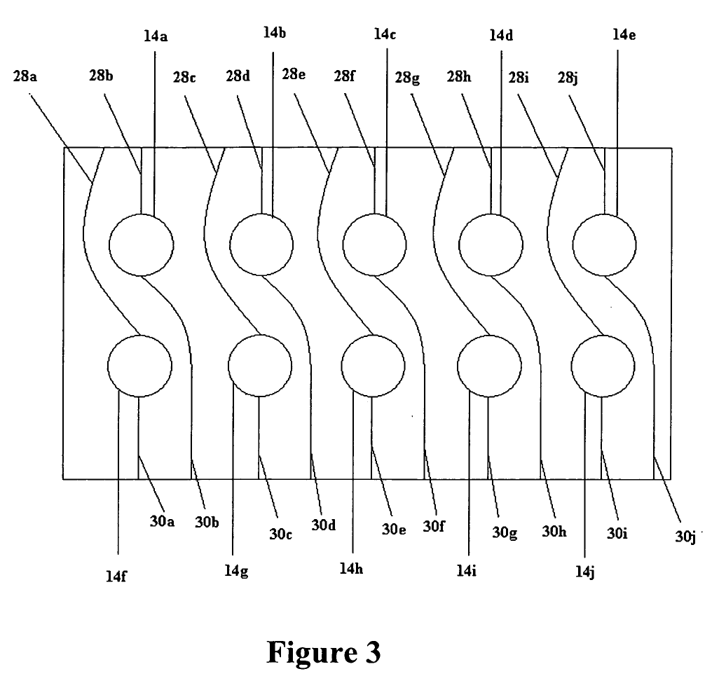

FIG. 3 is depicts one embodiment of an array of interconnected fuel cells (14a, 14b, 14c, 14d, 14e, 14f, 14g, 14h, 14i, 14j). A positive connection (28a, 28b, 28c, 28d, 28e, 28f, 28g, 28h, 28i, 28j) can connect each fuel cell to the electronic circuitry. A negative connection can connect each fuel cell to the electronic circuitry (30a, 30b, 30c, 30d, 30e, 30f, 30g, 30h, 30i, 30j). This embodiment is an array of interconnected fuel cells connected in parallel. The fuel cells can also be interconnected in series, or with a combination of series and parallel connections. Ten fuel cells are shown in this embodiment. Other embodiments can contain different numbers of fuel cells. For example, the array of fuel cells can be comprised of from 1 to 50,000 fuel cells.

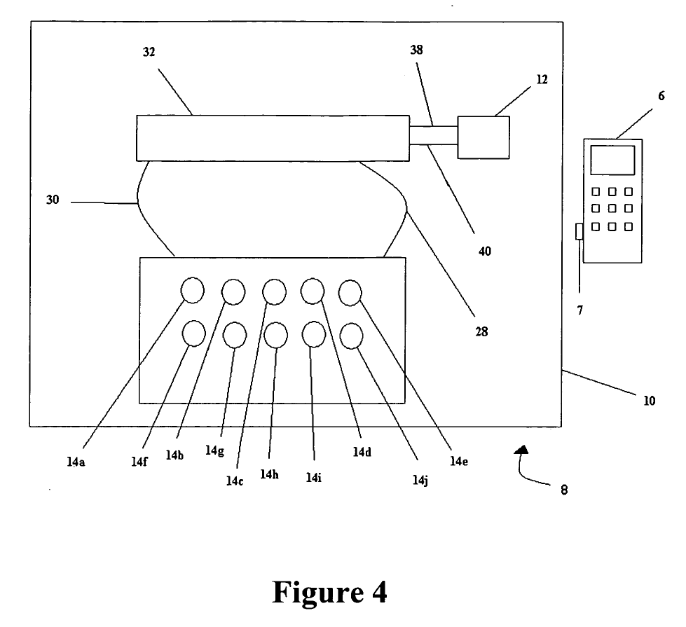

FIG. 4 depicts a system using fuel cell charger (8) according to one embodiment including a housing (10); a communication/power port (12) disposed in the housing (10); and at least one fuel cell (14a) adapted to generate electricity, wherein the fuel cell (14a) can be one or more fuel cells (14b, 14c, 14d, 14e, 14f, 14g, 14h, 14i, 14j). The fuel cell charger (8) includes, a fuel cell (14), and circuitry (32) adapted to provide power to an electronic device through the communication power port (12). The fuel cell charger can be used to provide power to an electronic device (6) having at least one interface port (7). Between the fuel cell (14a, 14b, 14c, 14d, 14e, 14f, 14g, 14h, 14i, 14j) and the circuitry (32) can be a first positive connection (28) and a first negative connection (30). Between the circuitry (32) and the communication power port (12) can be a second positive connection (38) and a second negative connection (40).

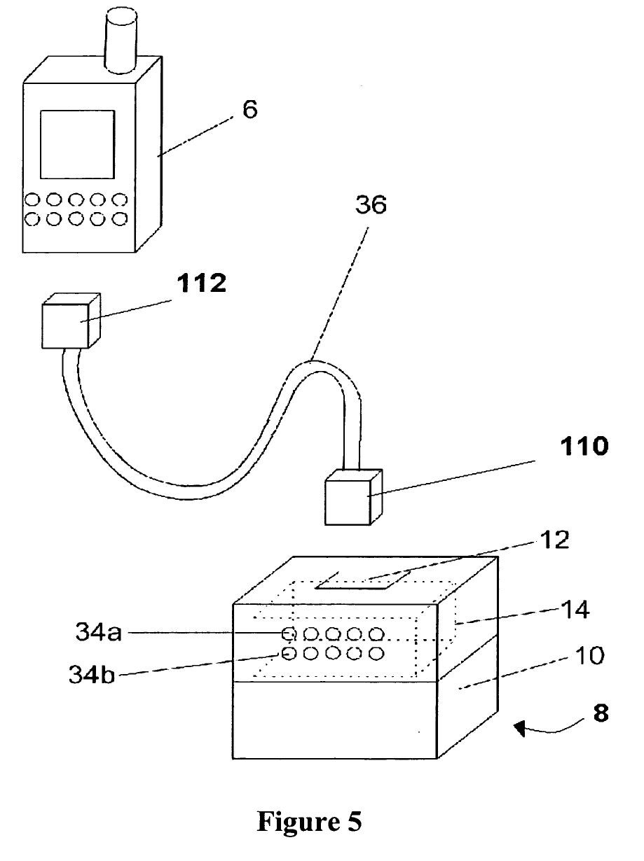

FIG. 5 is a fuel cell charger according to an embodiment including a housing (10); a communication/power port (12) disposed in the housing; and at least one fuel cell (14) inside the housing (10) adapted to generate electricity, wherein the fuel cell (14) can be one or more fuel cells. An electronic device (6) is connected to the communication/power port (12) using the interface (36). The interface (36) can be a cable with a first end (110) of the cable and a second end (112) of the cable. At least one hole (34a) can be formed in the housing to allow the oxygen in ambient air to act as the oxidant for the fuel cells, however multiple holes are shown (34a, and 34b). In this embodiment, the fuel is contemplated to be hydrogen and the electrolyte is contemplated to be a polymer electrolyte membrane, or proton exchange membrane (PEM).

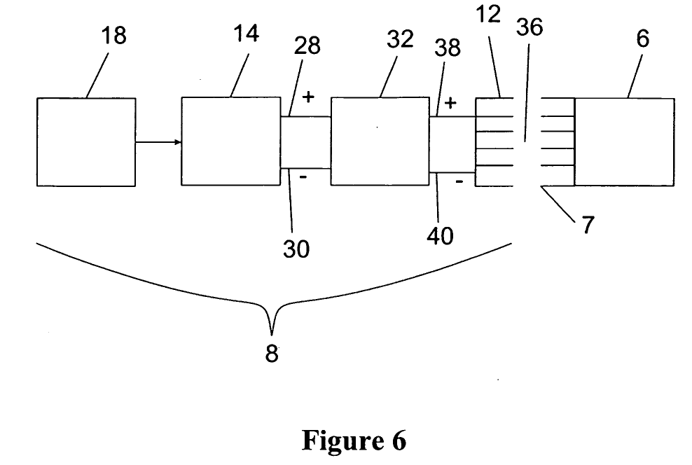

FIG. 6 shows a fuel cell charger (8) including, a fuel cell (14), with a fuel (18), and circuitry (32) adapted to provide power to an electronic device through the communication power port (12). The fuel cell charger can be used to provide power to an electronic device (6) having at least one interface port (7). An interface (36) can be used for connecting the fuel cell charger (8) to the electronic device (6). The interface (36) can be a cable connection which engages the interface port (7) of the portable electronic device (6). The interface (36) of this figure can be an insulated cable or wire with two connections, one connection engaging the communication power port (12) and one connection engaging the electronic device (6) through the interface port (7) to provide to power and to communicate with the electronic device (6). As an alternative to a flexible cable, the interface (36) can also be a rigid connector, with one end adapted to engage the interface port (7) of the electronic device (6), and the other end adapted to engage the communication power port (12). Between the fuel cell (14) and the circuitry (32) can be a first positive connection (28) and a first negative connection (30). Between the circuitry (32) and the communication power port (12) can be a second positive connection (38) and a second negative connection (40).

The circuitry (32) of the charger converts the fuel cell output down to a regulated output voltage usable by the electronic device. The circuitry could alternatively convert the fuel cell output up to a regulated output voltage usable by the electronic device, or it could convert the fuel cell output up or down as needed to a regulated output voltage usable by the electronic device. The circuitry can also include: a shut off feature, a voltage regulator, a power regulator, a current limiter, a fuel cell voltage limiter, an on/off indicator lamp, an electrical filter, a fuse, a power control for the fuel cell charger to pull power from the cell phone to start the fuel cell charger operation; or combinations thereof. In an embodiment, the circuitry is only a DC-DC converter using capacitors, or inductors, or combinations there of. The DC-DC converter can be connected to an integrated circuit chip for converting the fuel cell output to a range from 4.35 to 5.25 Volts. In an embodiment, the fuel cell charger can deliver an output current from 0 to 7.5 A. In another embodiment, the fuel cell charger can deliver an output current from 0 to 500 mA.

The present embodiments contemplate a method for charging an electronic device having the steps of connecting an interface of the charging device to an electronic device. The connection can be by plug in or by using the insulated cable described above. The next step can be activating the fuel cell charger by connecting an external load to the interface. The load closes the circuit, allowing the electronic device to charge. When the electronic device is charged, the next step is disconnecting the circuit. It is contemplated that this method can be used to charge a device for a time period ranging between 1 second and 5 million seconds.

The embodiments have been described in detail with particular reference to certain embodiments thereof, but it will be understood that variations and modifications can be effected within the scope of the embodiments, especially to those skilled in the art.

What is claimed is:

1. A fuel cell charger comprising:
(a) a housing;
(b) a communication power port disposed in the housing;
(c) an array of interconnected fuel cells comprising at least one fuel cell adapted to generate electricity, wherein the at least one fuel cell comprises:
i. a fuel plenum containing fuel;
ii. an anode connected to the fuel plenum;
iii. a cathode in communication with an oxidant;
iv. an ion-conducting electrolyte disposed between the anode and the cathode;
(d) a first positive connection connected to the cathode of the at least one fuel cell in the array of interconnected fuel cells;
(e) a first negative connection connected to the anode of at least one fuel cell in the array of interconnected of fuel cells; and
(f) circuitry connected to the first positive connection and the first negative connection, and wherein the circuitry further comprises connections to a second positive connection and a second negative connection to connect the circuitry to the communication/power port providing electrical energy to an electronic device.

2. The fuel cell charger of claim 1, wherein the housing comprises a sturdy plastic, metal, laminates and combinations thereof.

3. The fuel cell charger of claim 2, wherein the metal comprises stainless steel, aluminum or combinations thereof.

4. The fuel cell charger of claim 1, wherein the at least one fuel cell comprises a methanol fuel cell, a solid oxide fuel cell, an alkaline fuel cell, a polymer electrolyte membrane fuel cell, a proton exchange membrane fuel cell, or combinations thereof.

5. The fuel cell charger of claim 4, wherein the electrolyte comprises an ion conducting electrolyte.

6. The fuel cell charger of claim 1, wherein the fuel comprises: hydrogen, methanol, sodium borohydride, formic acid, a liquid fuel, butane, hydrogen stored in a metal hydride or combinations thereof.

7. The fuel cell charger of claim 1, wherein the oxidant comprises oxygen contained in ambient air.

8. The fuel cell charger of claim 1, further comprising one hole or a plurality of holes disposed in the housing to permit oxidant in ambient air to access the cathodes.

9. The fuel cell charger of claim 1, wherein the communication power port comprises a Universal Serial Bus (USB) port, wherein the USB port comprises a positive connection and a negative connection.

10. The fuel cell charger of claim 1, wherein the fuel cell charger produces an output voltage from 3 to 9 Volts.

11. The fuel cell charger of claim 1, wherein the fuel cell charger produces an output voltage from 4.35 to 5.25 Volts.

12. The fuel cell charger of claim 1, wherein the circuitry converts the electrical energy down to a regulated output voltage usable by the electronic device.

13. The fuel cell charger of claim 1, wherein the circuitry converts the electrical energy up to a regulated output voltage usable by the electronic device.

14. The fuel cell charger of claim 1, wherein the circuitry converts the electrical energy both up and down to a regulated output voltage usable by the electronic device.

15. The fuel cell charger of claim 1, wherein the array of fuel cells comprises from 1 to 50,000 fuel cells.

16. The fuel cell charger of claim 15, further comprising a connection between the fuel cells wherein the connection comprises parallel, serial, or combinations of parallel and serial connections.

17. The fuel cell charger of claim 1, wherein the fuel cell charger comprises a fuel shut off feature to shut off the flow of fuel to the anode.

18. The fuel cell charger of claim 1, wherein the circuitry comprises an on/off indicator lamp.

19. The fuel cell charger of claim 1, wherein the circuitry comprises a limiter to limit the output voltage, current, or power of the fuel cell charger.

20. The fuel cell charger of claim 1, wherein the circuitry comprises a limiter to limit the output voltage, current, or power of the fuel cell.

21. The fuel cell charger of claim 1, wherein the circuitry comprises a DC-DC converter further comprising: an energy storage component, connected to an integrated circuit chip for converting the fuel cell output to a range from 4.35 to 5.25 Volts.

22. The fuel cell charger of claim 1, further comprising as an interface to the communication power port of the fuel cell charger, a cable with a first cable end connected to the charger and a second cable end connected to the electronic device.

23. The fuel cell charger of claim 1, wherein the communication power port provides power and communication in an insulated connection through a USB port in the electronic device.

24. The fuel cell charger of claim 1, wherein the electronic device is a portable device.

25. The fuel cell charger of claim 1, wherein the communication power port comprises a VGA Video, SUN and SGI Video, MAC Video, SGI Open LDI, PS/2, PC/AT, serial mouse, RS232 DB9, RS232 DB25, USB Type A and B, Mini USB Type B, IEEE 1394, a RS232 RJ45 connector or combinations thereof.

26. A charging system for an electronic device using at least one fuel cell charger of claim 1.

27. A method for charging an electronic device comprising:
(a) connecting a fuel cell charger comprising a communication power port to the electronic device through an interface;
(b) activating the fuel cell charger;
(c) allowing the electronic device to charge; and
(d) disconnecting a circuit when the electronic device is charged.

28. The method of claim 27, wherein the communication power port comprises a USB port.

29. The method of claim 27, wherein the step of activating the fuel cell charger is automatic when the fuel cell charger is connected to the electronic device by the interface.

30. The method of claim 27, wherein the step of activating the fuel cell charger is accomplished by communication of data from the electronic device to the fuel cell charger through the communication power port.

31. The method of claim 27, wherein the step of disconnecting the circuit when the electronic device is charged is done automatically by the fuel cell charger.

32. The method of claim 27, wherein the electronic devices charges in a time period from 1 to 5 million seconds.
